(19) United States
(12) Patent Application Publication
(10) Pub. No.: US 2013/0054692 A1
(43) Pub. Date: Feb. 28, 2013

(54) Organizing and Tracking Belongings Using Social Graph Information

(71) Applicant: Zaheed Md Shahjahan Sabur, Adliswil (CH)

(72) Inventor: Zaheed Md Shahjahan Sabur, Adliswil (CH)

(73) Assignee: Google Inc., Mountain View, CA (US)

(21) Appl. No.: 13/221,683

(22) Filed: Aug. 30, 2011

(51) Int. Cl. G06F 15/16

(52) U.S. Cl. 709/204

(57) ABSTRACT

A system and machine-implemented method is provided for creating a new association of a belonging with a user within a social graph of belongings including receiving an input of a belonging from a first user of one or more users, generating a belonging profile associated with the belonging, associating the belonging profile with the first user within a social graph of belongings, generating a post and transmitting the post to be displayed to one or more contacts of the first user on a remote social networking site. Furthermore, a system and machine-implemented method is provided for retrieving and modifying a post including receiving a request to modify the post associated with a belonging, the post being displayed at a remote social networking site, retrieving the post from the remote social networking site, detecting one or more modifications of the at least one post and generating a modified post.

### BACKGROUND

The subject disclosure generally relates to organizing and tracking items, and, in particular, to organizing and tracking items owned or associated with users.

Social networking users typically share their activities related to purchasing of items with their contacts on social networking sites through posts and feeds. To do so, users may create a post in text form and may share the post with their contacts.

However, these item-related posts are typically mixed in with all other posts, and the user may not have control over the posts once they have been released. Since the posts are in text form, it is difficult to sort the shared information. Typically, users are not able to easily see what they have shared with other users about their products, have no control over who can see their posts once the posts have been released, and cannot modify the posts after they have been created and shared. Thus, a convenient way for viewing and managing product related posts may be desirable.

### SUMMARY

The disclosed subject matter relates to a machine-implemented method for creating a new association of a belonging with a user within a social graph of belongings, the method comprising receiving an input of a belonging from a first user of one or more users, generating a belonging profile associated with the belonging, associating the belonging profile with the first user within a social graph of belongings, generating a post, wherein the post comprises a link to the belonging profile and a link to the first user and transmitting the post to be displayed to one or more contacts of the first user on a remote social networking site.

The disclosed subject matter also relates to a system for creating a new association of a belonging with a user within a social graph of belongings, the system comprising one or more processors and a machine-readable medium comprising instructions stored therein, which when executed by the processors, cause the processors to perform operations comprising receiving an input of a belonging from a first user of one or more users, wherein the input comprises information regarding the belonging, generating a belonging profile associated with the belonging, the belonging profile comprising the information and associating the belonging profile with the first user within a social graph of belongings, wherein the social graph of belongings defines an association between each of the one or more users and one or more belongings.

The disclosed subject matter also relates to a machine-readable medium comprising instructions stored therein, which when executed by a machine, cause the machine to perform operations comprising receiving an input of a belonging from a first user of one or more users, generating a belonging profile associated with the belonging, associating the belonging profile with the first user within a social graph of belongings, generating a post, wherein the post comprises a link to the belonging profile and a link to the first user, retrieving a list of a plurality of contacts of the first user from a remote social networking site, the plurality of contacts comprising contacts of the first user at the remote social networking site and transmitting the post to be displayed to one or more of the plurality of contacts of the first user on the remote social networking site.

The disclosed subject matter further relates to a machine-implemented method for retrieving and modifying belonging-related posts, the method comprising receiving a request to modify at least one post associated with a belonging, the post being displayed at a remote social networking site, retrieving the at least one post from the remote social networking site, wherein retrieving the at least one post comprises retrieving a unique identifier associated with the at least one post and retrieving the at least one post using the unique identifier, detecting one or more modifications of the at least one post, generating a modified post and transmitting the modified post to be displayed to one or more contacts of the user on the remote social networking site.

The disclosed subject matter further relates to a system for retrieving and modifying belonging-related posts, the system comprising one or more processors and a machine-readable medium comprising instructions stored therein, which when executed by the processors, cause the processors to perform operations comprising receiving a request to modify at least one post associated with a belonging, the at least one post being displayed at a remote social networking site, wherein the belonging is associated with a first user of one or more users within a social graph of belongings, wherein the social graph of belongings defines an association between each of the one or more users and one or more belongings, retrieving the at least one post from the remote social networking site, wherein retrieving the at least one post comprises retrieving the at least one post using a unique identifier associated with the post, detecting one or more modifications of the at least one post, generating a modified post and transmitting the modified post to be displayed to one or more contacts of the user on the remote social networking site.

The disclosed subject matter also relates to a machine-readable medium comprising instructions stored therein, which when executed by a machine, cause the machine to perform operations comprising receiving a request to modify at least one post associated with a belonging, the at least one post being displayed at a remote social networking site, wherein the belonging is associated with a first user of one or more users within a social graph of belongings, wherein the social graph of belongings defines an association between each of the one or more users and one or more belongings, each of the one or more users associated with one or more belongings, retrieving the at least one post from a remote social networking site, wherein retrieving the at least one post comprises retrieving a unique identifier associated with the at least one post and retrieving the at least one post using the unique identifier, detecting one or more modifications of the at least one post, generating a modified post, the modified post having a link to the belonging and a link to the first user and associating the post with the unique identifier.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment, which provides for managing belonging-related information using a social graph of belongings.

FIG. 2 illustrates a screen-shot of an example graphical user interface displayed to a user upon logging into a system for managing a social graph of belongings.

FIGS. 3A and 3B illustrate screen-shots of an example graphical user interface for adding a new belonging to the belongings of a user.

FIG. 4 illustrates a screen-shot of an example graphical user interface for viewing and sharing a post representing the belonging added in FIGS. 3A and 3B.

FIGS. 5A, 5B and 5C illustrate screen-shots of an example graphical user interface for viewing and managing a belonging profile of the belonging added in FIGS. 3A and 3B.

FIG. 6 illustrates a screen-shot of an example graphical user interface for viewing and managing a belonging profile of a private belonging.

FIG. 7 illustrates a screen-shot of an example graphical user interface for viewing and managing a belonging profile of a user.

FIG. 8 illustrates a flow chart of a process for generating and maintaining a social graph of belongings.

FIG. 9 illustrates a flow chart of a process for generating and distributing a post representing a user activity with respect to a belonging.

FIG. 10 illustrates a flow chart of a process for tracking and modifying belonging-related posts.

FIG. 11A illustrates a screen shot of an exemplary graphical user interface for modifying a belonging-related post.

FIG. 11B illustrates a screen shot of an exemplary graphical user interface providing a confirmation message to the user.

FIG. 12 illustrates an exemplary social graph of belongings.

FIG. 13 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

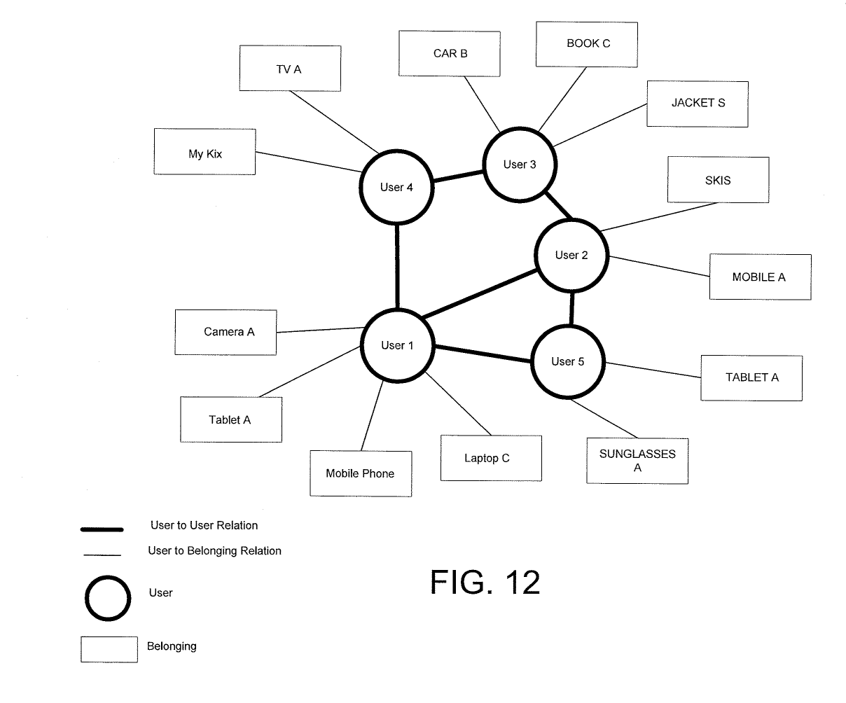

As used herein, “belongings” refer to items owned by a user or items a user has indicated that the user is looking to own, borrow or learn more about. A user's belongings may include items purchased online (e.g., through an internet based retailer), offline (e.g., at regular retail stores), or received as gifts. In accordance with the subject disclosure, a method and a system are provided for building a social graph of belongings of one or more users. In one instance, each user of the system may add one or more belongings, and the system may associate each of the belongings with the user. Thus, in one example of the subject disclosure, a social graph of belongings may include associations between a user and their belongings. In one example, the social graph of belongings may further include associations between users (e.g., by leveraging existing social graphs at one or more remote social networking sites). An exemplary social graph of belongings is described in further detail below with respect to FIG. 12.

In one example, the system may allow users of the system to share activities related to their belonging with their contacts. As used herein, “posts” generally refer to any displayable notification or announcement regarding activities performed with respect to a belonging, including for example comments, replies, announcements, status updates, digital photos, videos or other appropriate electronic information. Activities related to belongings may include adding a belonging, adding reviews regarding a belonging, adding a description regarding the belonging, modifying one or more attributes of a belonging, sharing the belonging, or indicating a state for the belonging.

Users of remote social networking sites may create associations with one another. These associations may be stored within a social graph at each remote social networking site (e.g., maintained at remote server(s) 120). Such user associations may be defined on a user-to-user basis, or as a group of users associated through membership within a group. As used herein, “contacts” refer to a user's friends, social circles, groups and other users that the user is associated with, at one or more remote social networking sites.

As used herein, “social circles” are categories to which a user can assign their social networking contacts and better control the distribution and visibility of social networking messages. In accordance with the subject disclosure, a social circle is provided as a data set defining a collection of contacts that are associated with one another. As used herein, a social circle can be described from the perspective of an individual that is the center of a particular collection of socially interconnected people, or from the aggregate perspective of a collection of socially interconnected people. In some examples, a social circle can have narrowly defined boundaries, all of the members of the social circle may be familiar with one another, and permission may be required for a member to join a social circle. In accordance with the subject disclosure, a user of an electronic device may define a social circle, and the social circle, as a data set defining a collection of contacts, may reflect a real-life social circle of the user.

For example, a user of an electronic device may have different groups of friends, coworkers, and family, and there may be some overlap among those groups (e.g., a coworker who is also considered to be a friend, a family member who is also a coworker). Through the creation and use of social circles, the user can organize and categorize social networking contacts into various different groupings.

The system may leverage existing social graphs maintained at one or more remote social networking sites to facilitate distribution of posts with contacts of a user. For example, one or more remote social networking sites may maintain a social graph of users and their contacts. The system may access social graphs maintained at these remote social networking sites and retrieve contacts of the users of the system. In one instance, the user may indicate membership at one or more remote social networking sites and provide the system with access to these remote social networking sites, for example, through a token. The contacts retrieved by the system may depend upon the specific privacy settings enforced at each of the remote social networking sites.

The system may, upon accessing the remote social networking sites, retrieve information with respect to one or more users of the system and their associated contacts. Using the retrieved contacts, the system can then allow users of the system to share posts related to their belongings with their contacts. The post may then be distributed to the one or more remote social networking sites to be displayed to the user's contacts at the remote social networking site. The system may allow the user to choose specific contacts or groups of contacts at the one or more remote social networking sites with whom the post is shared. In one example, some or all of the remote social networking sites may provide support for selectively sharing posts with one or more contacts of the users.

The system may further provide for tracking the shared posts. In one example, prior to the post being distributed to the one or more remote social networking sites, each post may be assigned a unique identifier to facilitate tracking and control of the post once the post has been distributed either locally or to one or more remote social networking sites. The unique identifier may be associated with a belonging the post is related to and/or a user associated with the specific belonging. In one exemplary instance, the system tracks the post through the unique identifier. For example, the post may be linked with the unique identifier such that after distribution the post may be retrieved and modified using the link, even after the post has be distributed and displayed to contacts.

Additionally, the system may allow users of the system to borrow or lend belongings to one or more other users of the system. For example, a first user may request to try out a belonging of a contact owning the belonging (e.g., to further help the user in making a decision regarding purchasing the item corresponding to the belonging). For example, a user may generate a request, post or comment, displayed to one or more contacts, to borrow an item corresponding to a belonging owned by one or more contacts or specifically a belonging of a contact. The system may further allow users to keep track of items they have borrowed as well as items they have lent to other users of the system.

Once a belonging is lent to the user, the contact may modify the state of the belonging (e.g., by interacting with a graphical user interface of the system displaying a belonging profile), or reorganize the belonging within a specific belonging category, to indicate that the item has been lent, and may further indicate that the item has been lent to the user. The system may then modify the state of the belonging within the social graph of belongings and may further store the information regarding the user the item has been lent to. The system may further create a new association between the user and the belonging lent to the user within the social graph of belongings. The belonging may then be indicated as being borrowed in the user's belongings, and may further include information regarding the owner of the belonging (e.g., contact of the user). Thus, both the user and his/her contact may keep track of the belonging having been lent to the user. In response to the borrowing/lending of belonging the system may detect a belonging related activity and may generate a post to be distributed to one or more contacts of the user, and/or contact of the user owning the belonging.

Furthermore, a user of the system may add a belonging to his/her profile and may indicate the belonging as an item the user wishes to purchase, own or borrow (hereinafter referred to as a “wish list belonging”). As used herein, a “wish list belonging” may refer to a belonging which a user may wish to own, purchase, borrow, and/or learn more about. For example, such belongings may be included within the social graph of belongings associated with the user. The wish list belongings may be assigned to a belonging category dedicated to belongings the user may not own but may wish to own, purchase, or borrow, and/or belongings the user may be generally interested in purchasing. For example, in one aspect, the user may add a belonging and may add the belonging to a category indicated for wish list belongings of the user. In another example, the user may assign a state to each belonging when the belonging is being added. The state of a belonging may be indicated as wish to purchase, wish to borrow, wish to own or wish to learn more about. In one aspect, contacts of the user may view the belongings indicated as a wish list belonging and may provide comments and feedback regarding the belonging, and may further offer to lend the belonging to the user. The user may further be provided with a list of contacts owning a belonging corresponding to the wish list belonging, and may request to borrow the belonging (e.g., by creating and distributing a post).

In one aspect, when adding a belonging (e.g., a wish list belonging), the user may enter a name of a belonging or other indication of a belonging name or identification. The system may then determine a full name or identifier of the item associated with the belonging and may associate the belonging with the item corresponding to the belonging. Thus, each belonging within the social graph of belongings corresponds to an item, and therefore while each belonging is unique and customized to the user associated with the belonging, one or more belongings may correspond to the same or similar item. In this manner, the belongings of the user may be more accurately stored using actual product names. The user may alternatively be presented with specific queries regarding the entered product such as serial number information, product version, product name, product developer and other product specific information, to determine the actual item associated with the belonging being inputted by the user.

When a user wishes to borrow an item or try out the item (e.g., a wish list belonging or item the user wishes to purchase), the system may identify one or more belongings within the social graph of belongings corresponding to the same item and may present the belongings to the user. The system may further only present the belongings identified and owned by a contact of the user or shared with the user, such that the user may request to borrow the belonging. The system may then keep track of whether a contact of the user lends the belonging to the user and may keep track of the item being lent to the user.

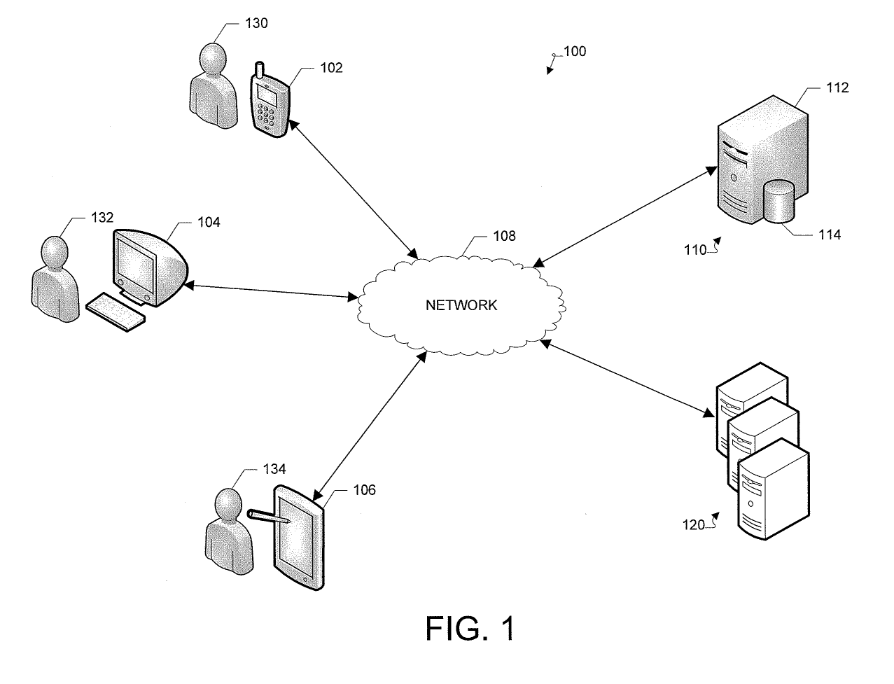

FIG. 1 illustrates an example client-server network environment, which provides for managing belonging-related information using a social graph of belongings. A network environment 100 includes a number of electronic devices 102-106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example embodiments, electronic devices 102-106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In one embodiment, server 110 includes a processing device 112 and a data store 114. Processing device 112 executes computer instructions stored in data store 114, for example, to facilitate managing belonging-related information associated with users interacting with electronic devices 102-106. Server 110 may further be in communication with remote servers 120 either through the network 108 or through another network or communication means.

According to some aspects, remote servers 120 can be any system or device having a processor, a memory and communications capability for hosting various remote social networking sites. In one embodiment, remote servers 120 may be further capable of maintaining social graphs of users and their contacts. The remote social networking sites hosted on the remote server 120 may enable users to create a profile and associate themselves with other users at a remote social networking site. The remote servers 120 may further facilitate the generation and maintenance of a social graph including the user created associations. The social graphs may include, for example, a list of all users of the remote social networking site and their associations with other users of a remote social networking site.

In some example aspects, server 110 and/or one or more remote servers 120 can be a single computing device such as a computer server. In other embodiments, server 110 and/or one or more remote servers 120 can represent more than one computing device working together to perform the actions of a server computer (e.g., cloud computing). In some embodiments, server 110 and/or one or more remote servers 120 may be coupled with various remote databases or storage services. Communications between the client devices 102-106, server 110 and/or one or more remote servers 120 may be facilitated through the HTTP communication protocol. Other communication protocols may also be facilitated including for example, XMPP communication, for some or all communications between the client devices 102-106, server 110 and one or more remote servers 120.

Users 130-134 may interact with the system hosted by server 110, and/or one or more social networking sites hosted by remote servers 120, through a client application installed at the electronic devices 102-106. Alternatively, the user may interact with the system and the one or more remote social networking sites through a web based browser application at the electronic devices 102-106. Communication between client devices 102-106 and the system, and/or one or more remote social networking sites, may be facilitated through a network (e.g., network 108).

In one embodiment, users 130-134 may interact with the system maintaining a social graph of belongings, which is hosted at the server 110, to manage their belongings. Users 130-134 operating electronic devices 102-106 can manage their belongings, share their belonging-related activities with contacts and control track and modify their posts (e.g., using server 110). For example, users 130-132 may access the system and may create a user profile including a user belonging profile.

In one aspect, upon receiving a user request to interact with the system at a client device (e.g., electronic devices 102-106), the client device may initiate a communication with the system and send a data set including login information of the user. The data set can be transmitted from the user's client device (e.g., electronic devices 102-106) and received at server 110 hosting the system, for user authentication. Once the user is authenticated and access is granted to the user, the system may retrieve and send a data set to the user's client device, for displaying a graphical user interface at the client device operated by the user (e.g., electronic devices 102-106).

The system may further send a query to the user's client device (e.g., displayed within the graphical user interface displayed at the client device) for information regarding one or more social networking sites the user is associated with. Upon receiving a response from the user's client device (e.g., in response to a selection by the user operating the device) the system may initiate establishing communication with one or more remote social networking sites (e.g., through network 108 and remote servers 120). For example, the system may cause the client device to reroute the user to the social networking site. The user's client device may then communicate with the social networking site and send login information to the social networking site, for example by sending a data set including the login information. The social networking site may authenticate the user using the received data set and may provide the user's client device with a token (e.g., a temporary token). The system hosted at server 110 may then retrieve the token from the user's client device, and may establish communication with one or more servers 120 hosting the remote social networking site using the token. For example, the communication may be facilitated using API calls. Similar steps may be performed for each of the one or more social networking sites associated with the user operating the client device.

Upon being granted access to each of the one or more social networking sites (e.g., through one or more remote servers 120), the system may then issue a request to each remote social networking site associated with the user to retrieve all contacts of the user. In one embodiment, for example, the system (e.g., through server 110) may issue an API call sent to the social networking site (e.g., sent from server 100 to one or more remote servers 120 through network 108). In one aspect, a remote social networking site hosted by one or more remote servers 120, may maintain a social graph comprising all contacts of each of its members, including the user. The social graph may be stored at the storage at the one or more remote servers 120 or may be stored remotely and the one or more remote servers 120 may access the remote storage and retrieve such information. The social networking site may access the social graph and may retrieve the contacts of the user. The social networking site may further retrieve information associated with each contact or the association of the user with the contact, such as privacy preferences. The one or more remote servers 120 hosting the social networking site may provide the system (e.g., through server 110) with data sets including the contacts of the user, and may do so based upon contact information such as the privacy preferences. The server 110, upon receiving the contact information from one or more remote social networking sites, may store the data set including the contact information for each user (e.g., within the belonging profile of the belonging) at the server 110 (e.g., at storage 114). In one aspect, the contact information maintained at the server 110 may be updated periodically, by issuing a request to the one or more remote social networking sites (e.g., through one or more remote servers 120) and receiving updated data sets including user contact information.

The system may then provide the user's client device with an updated graphical user interface including the retrieved contacts of the user. Users 130-132 may interact with the graphical user interface provided by the system and displayed at the user's client device to add one or more belongings to their user belonging profile. Each user may further enter belonging attributes regarding their belongings, such as a belonging name, a belonging image, a description and review regarding the belonging. Additionally, purchase information regarding a belonging may further be entered by a user of the system for each of the user's belongings. For example, information such as purchase receipts, warranty information and other such information may be inputted by the user and may be maintained at the system. Still further, a user may assign a state for each of his/her belonging maintained within the social graph of belongings. A “belonging state” as used herein may refer to a status of the belonging. Belonging states may include, for example, the belonging being owned, borrowed, for sale, reviewed, given away, lent, or being a belonging the user wishes to buy, borrow or own. Each user may additionally organize their belongings into different belonging categories, and may further select contacts with whom activities regarding the newly added belonging may be shared. The entered information may then be sent from the user's client device, as a data set, to the system (e.g., through server 110) and may be stored at the server (e.g., at storage 114). The system (e.g., through server 110) may use the received information within the data set and may update the social graph of belongings maintained at the system (e.g., through server 110).

In addition to receiving belonging information, the system may further receive requests from the user's client device when the user wishes to share activities related to their belongings with contacts. Upon detecting a belonging-related activity performed by the user or upon a request from the user's client device to the system, the system may generate a post related to a belonging. Upon generating the post, the system may issue requests (e.g., API calls) to one or more remote social networking sites to display the post to selected contacts of the user at the one or more remote social networking sites. A data set including the post may be sent to the one or more social networking sites. The social networking site may then use the information included within the data set to display the post at the remote social networking site. Thus, the system may provide a platform where users can organize and share their belongings in a centralized and more effective way.

Posts generated with respect to belonging by users of the system may be stored within a database accessible by the system (e.g., at storage 114). A user of the system may interact with a graphical user interface displayed at the user's client device to request to access posts regarding a belonging, and/or modify the posts regarding a belonging in response to an event (e.g., the belonging being sold, the belonging being lent, updated experience or views regarding the belonging, etc.). Upon receiving the request, the system may access the database storing the posts relating to belongings and may identify all posts associated with a specific belonging and/or all of the belongings of the user, and may generate a dataset of the posts. The dataset is then used to update the graphical user interface at the user's client device to display a listing of the posts such that the user may view and modify one or more of the posts.

The system may provide users with the ability to easily share information about their belongings, know and control what is shared and with whom, preserve valuable information about their belongings, organize all the information shared regarding their belongings, including reviews and comments in one place, share their wishes to borrow or buy an item with their contacts, seek recommendations from their contacts, sell, buy, give away, borrow and led their belongings, and search and browse belongings of their contacts.

While each of the users 130-134 may interact with the system through their respective client device 102-106, for exemplary purposes the interactions between the users and the system is hereinafter described with reference to user 130. In many instances, each user 130-134 may interact with the system in the same or similar manner described below with respect to user 130.

In one exemplary embodiment, user 130 interacting with electronic device 102 may register with the system hosted by server 110 and create a user profile. In one embodiment, upon registration, user 130 may access the system and add one or more belongings. User 130 may further share activities performed with respect to those belongings with his/her contacts on one or more remote social networking sites directly through the system hosted by server 110.

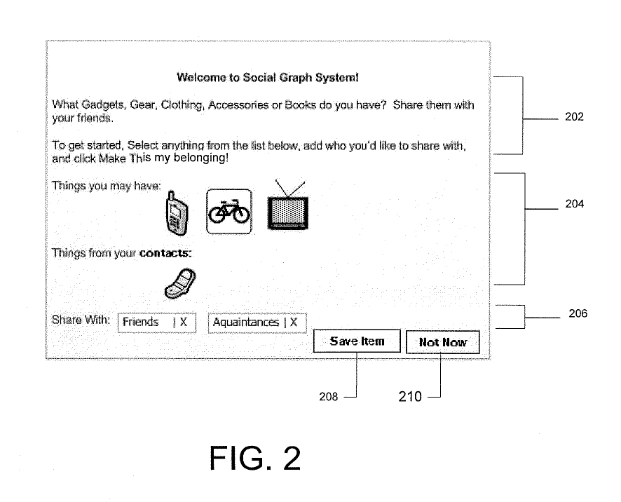

FIG. 2 illustrates a screen-shot of an example graphical user interface displayed to user 130 upon logging into the system for managing a social graph of belongings. In one example implementation, user 130 may interact with the system by logging into the system using pre-stored login information (e.g., a user name and password). If user 130 is a first time user, user 130 may register with the system and create login information (e.g., a user name and password) to be used for subsequent access to the system. Upon entering the system, user 130 may then be provided with the graphical user interface of FIG. 2.

In one instance, the graphical user interface of FIG. 2 illustrates a welcome message section 202 for displaying a welcome message to user 130. The welcome message may include text such as such as a general welcome note, a set of instructions and/or a description of services provided by the system.

The graphical user interface of FIG. 2 further illustrates a belonging suggestion section 204, displaying one or more possible belongings to user 130. As illustrated in the graphical user interface of FIG. 2, the belonging suggestion section 204 may display items identified by the system as items user 130 is likely to want to add as a belonging, and may further display belongings recently added by contacts of user 130. The belonging suggestion section 204 may only be displayed if user 130 has previously interacted with the system. The section of the belonging suggestion section 204 displaying items from contacts may be populated once user 130 provides the system with access to one or more remote social networking sites. For example, user 130 may be provided with an option to indicate one or more remote social networking sites he/she is a member of and may provide the system with access to these remote social networking sites.

Furthermore, the graphical user interface of FIG. 2 illustrates a contact selection section 206. As illustrated in the graphical user interface of FIG. 2, the contact selection section 206 may display all contacts or groups of contacts (e.g., social circles) associated with user 130. Alternatively, the contact selection section 206 may display the most recent contacts user 130 has shared his/her posts with and may display those contacts or contact groups to the user. The user 130 may remove one or more contacts or contact groups, or may add one or more additional contacts or contact groups within the content selection section 206. In another instance, the content selection section may display other ways for selecting contacts, such as a drop down menu of all contacts and contact groups or a search tab for searching for contacts or contact groups by name. The contacts and contact groups displayed in contact selection section 206 may only be presented once the user provides the system with access to the one or more remote social networking sites the user is a member of, enabling the system to retrieve the user's contacts from those remote social networking sites.

As illustrated in the graphical user interface of FIG. 2, a “save item” button 208 and a “not now” button 210 are further displayed to the user. The save item button 208 may be grayed out until user 130 selects any of the items displayed in the belonging suggestion section 204, then the save item button 208 is illuminated, allowing the user to select to save the selected item as a belonging. The not now button 210, in one instance, allows the user to skip the graphical user interface of FIG. 2 and continue onto the system.

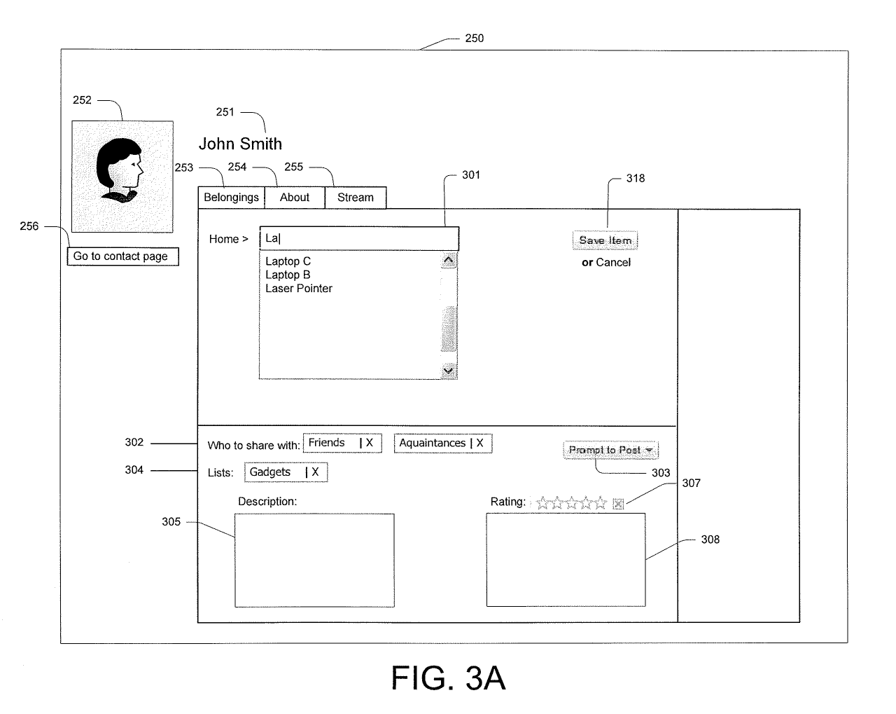

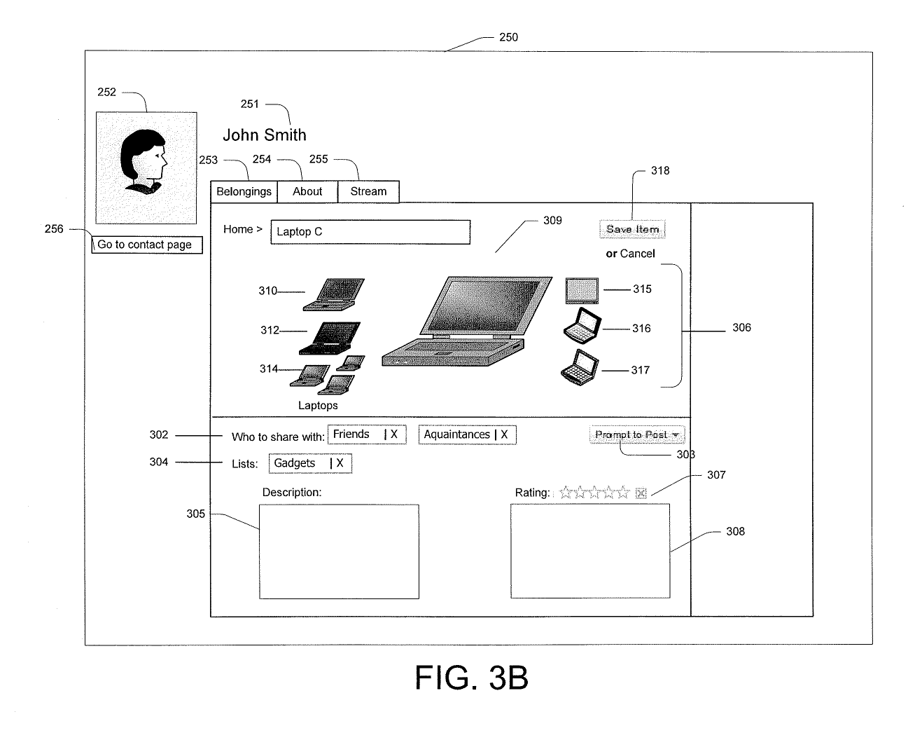

Once in the system, user 130 may be presented with a graphical user interface displaying a user profile associated with user 130 (e.g., user profile 250 illustrated in FIGS. 3-7). The user profile 250 may include general information regarding user 130, including the name of user 130 (251) and an image of the user 130 (252). Furthermore, a contact entry box 256 may be provided to allow the user to enter names of contacts. Upon entering a contact name, the user may then be able to navigate to the belonging profile of a contact and may be able to browse the belongings of the contact. The user profile may also include multiple tabs, such as a “belongings” tab 253, an “about” tab 254 and a “stream” tab 255. The about tab 254 may include basic information regarding user 130 such as a list of contacts, an email address, and other such information. In one instance, such information may be entered by the user upon registering with the system. The user information may be stored within a user profile. The stream tab 255 may display a stream of posts related to belongings and associated with the user (e.g., streams similar to those displayed within the stream section 507 and stream section 704). The belongings tab 253 may provide the user with one or more graphical user interfaces (e.g., the graphical user interfaces of FIGS. 3-7) enabling the user to interact with the system to add one or more belongings, to manage and control belongings, and to perform other belonging-related activity.

FIGS. 3A and 3B illustrate screen-shots of an example graphical user interface for adding a new belonging to the belongings of a user. The graphical user interface of FIG. 3A illustrates an item entry section 301. The item entry section 301 is illustrated as a text entry box, which may have an auto fill option such that user 130 enters a section of an item name within the text entry box and the system provides one or more possible items. User 130 may either complete the name or may select one of the auto fill options provided in the drop down list. The system may receive the user's input within the text entry box of item entry section 301, may auto-compute possible items, and may present the items as options to the user. In this manner, the belongings of the user may be more accurately stored using actual product names. The user may alternatively be presented with specific queries regarding the entered product such as serial number information, product version, product name, product developer and other product specific information, to determine the actual item associated with the belonging being inputted by user 130.

User 130, may alternatively enter a belonging using an identifier of the belonging (e.g., a bar code, product serial number) and the system may determine the item using the identifier. In one aspect, user 130 may select to label the item using a personalized name. The system may store the belonging with the personalized name, and may further associate the belonging with the item corresponding to the belonging.

Once user 130 enters the name of the belonging, or selects the intended belonging from the auto fill options provided, at the item entry section, one or more available images of the selected item may be displayed to the user within the image selection section 306 as illustrated in the graphical user interface of FIG. 3B. The images displayed with the image selection section 306 may include images uploaded by user 130, and/or images retrieved by the system based on the information entered within the item entry section 301. One or more images of an item may be displayed to the user as illustrated in the graphical user interface of FIG. 3B. In one instance, as illustrated in the graphical user interface of FIG. 3B, a first image 309 may be displayed as a main image, with alternative images 310-317 additionally displayed. Alternatively, fewer or no alternative images may be displayed to the user. User 130 may select to change the main image by selecting the change picture option illustrated in the graphical user interface of FIG. 3B. In one example, the alternative images 310-317 may be displayed once user 130 chooses to change the picture. The user may thus select the desirable image to be associated with the belonging.

The graphical user interface of FIGS. 3A and 3B further illustrate a contact selection section 302. In one embodiment, the contact selection section 302 may display all contacts or groups of contacts (e.g., social circles), associated with the user 130. Alternatively, the contact selection section 302 may display the most recent contacts user 130 has shared his/her post with and may display those contacts or contact groups to user 130. User 130 may remove one or more contacts or contact groups or may add one or more additional contacts or contact groups within the content selection section 302. The contact selection section 302 may display other ways for selecting contacts, such as a drop down menu of all contacts and contact groups or a search tab for searching for contacts or contact groups by name.

In one embodiment, the contacts and contact groups displayed in contact selection section 302 represent contacts of the user stored within the social graph of one or more remote social networking sites. In one instance, contacts and contact groups of user 130 are presented once user 130 provides the system with access to the one or more remote social networking sites the user is a member of. For example, in one aspect, the contact selection section 302 of the graphical user interface of FIG. 3A may include icons for one or more remote social networking sites. The remote social networking sites, in one aspect, include remote social networking sites hosted by remote servers 120 and in communication with the system (e.g., through network 108). The system, in one instance, includes the capability to facilitate communication with the one or more remote networking sites, and is able to access the social graphs maintained at the remote social networking sites and retrieve contacts of a user stored within the social graph maintained at each remote social networking site.

According to several embodiments of the present system, user 130 may select the icons for each remote social networking site at which user 130 has contacts. In some aspects, the selection of the icon for each remote social networking site will reroute user 130 to the remote social networking site where the user may log into the social networking site using his/her login information pertaining to the selected remote social networking site. The user may then be routed back to the system with a token, enabling the system to access the user's information and contacts at the selected remote social networking site and retrieve the user's contacts.

The graphical user interface of FIGS. 3A and 3B further illustrate a sharing preference selection menu 303. The sharing preference selection menu allows user 130 to have control over how his/her belonging-related posts and activities are shared with contacts. The graphical user interface of FIGS. 3A and 3B illustrate the sharing preference selection menu 303 being set at the “prompt to post” option. In some instances, when user 130 has selected the prompt to post option, the system may generate a post when a new activity with regard to the belonging being added is selected. The system then prompts user 130 that the post has been generated and the user will choose whether to share the post, or to forgo sharing the activity with contacts. User 130 may, in some instances, modify the text of the generated post before selecting to share the post with his/her contacts.

In addition to the prompt to post option illustrated in the graphical user interface of FIGS. 3A and 3B, the sharing preference selection menu 303 may provide additional options including, for example, never sharing posts related to the belonging being added in the graphical user interface of FIGS. 3A and 3B, and always sharing posts related to the belonging being added in the graphical user interface of FIGS. 3A and 3B, without first prompting the user. The additional sharing preference options may be selectable by the user through a drop down arrow illustrated on the sharing preference selection menu 303 of the graphical user interface of FIGS. 3A and 3B.

The graphical user interface of FIGS. 3A and 3B further illustrate a belonging categorization section 304. The belonging categorization section 304 allows user 130 to categorize the belonging being added. User 130 may organize his or her belongings into different categories such as for example gadgets, books, sports gear, wardrobe and electronics. According to several aspects, there may virtually be no limitation on the number or name of the belonging categories created by user 130. In one embodiment, the belonging categorization section may display all categories created by user 130. Alternatively, the belonging categorization section 304 may display the most recent category used by user 130. User 130 may remove one or more categories or may add one or more additional categories within the belonging categorization section 304. The belonging categorization section 304 may display other ways for selecting categories, such as a drop down menu of all categories created by the user or a search tab for searching for categories by name. In some instances, user 130 may be able to place the same belonging within multiple categories.

A description entry box 305 is further illustrated in the graphical user interface of FIG. 3A, allowing user 130 to enter a description regarding the belonging being added. Similarly, a rating entry box 308 and rating indicator 307 are illustrated in the graphical user interface of FIG. 3A. A user may rate the belonging being added using the rating indicator 307, for example by clicking on a specific star, indicating the rating of the belonging. User 130 may further enter comments or reviews regarding the belonging in the rating entry box 308. In one or more aspects, the description entry box 305 and rating entry box 308 may accept any text and/or graphical entry.

In one aspect, additional data fields may further be provided to user 130 in the graphical user interface of FIGS. 3A and 3B and the user may enter further information regarding a belonging. For example, purchase information regarding a belonging may be entered by user 130 for one or more of his/her belongings. Such purchase information may include information such as purchase receipts, warranty information and other such information. Such information may be received and maintained at the system for future use. As another example, a user may assign a state of each of his/her belonging maintained within the social graph of belongings. A “belonging state” as used herein may refer to a status of the belonging. Belonging states may include, for example, the belonging being owned, borrowed, for sale, reviewed, given away, lent, or being a belonging the user wishes to buy, borrow, own. In another embodiment, the belonging state may be automatically assigned by the system (e.g., upon detecting that the item has been purchased).

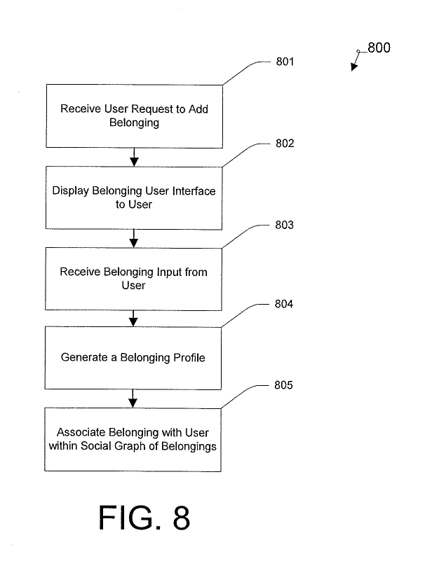

The graphical user interface of FIGS. 3A and 3B further illustrate a “save item” button 318. Once user 130 has completed all information regarding the belonging, user 130 may select the save item button 318. The selection of the save item button 318 prompts the system to add the belonging to the social graph of belongings. Upon detecting that user 130 has added a belonging, the system may initiate the process of adding the belonging to the social graph of belongings maintained by the system. This process is described in further detail below with respect to FIG. 8.

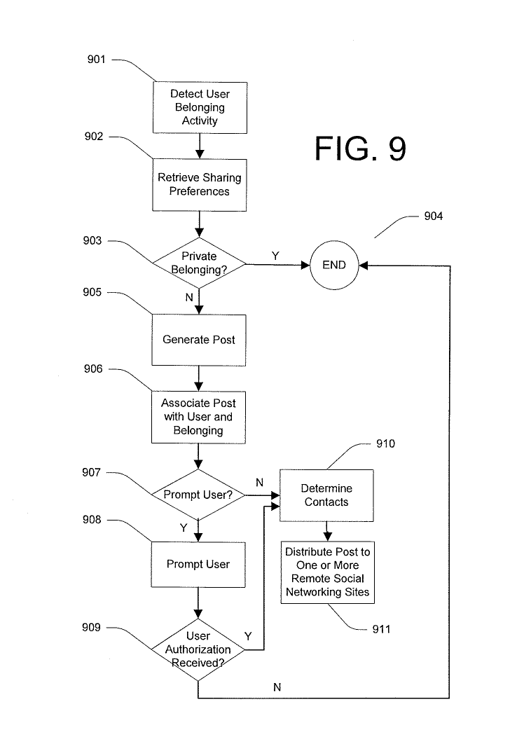

The system may further detect the sharing preference of user 130, for example as indicated by the option user 130 selected from the sharing preference selection menu 303. Based upon the preference indicated by user 130, the system may generate a post to be shared with the selected contacts of user 130. For example, if the user selected the prompt to post option or the always post option, the system will generate a post indicating user 130 has added a new belonging. The process of generating and distributing posts is described in further detail below with respect to FIG. 9.

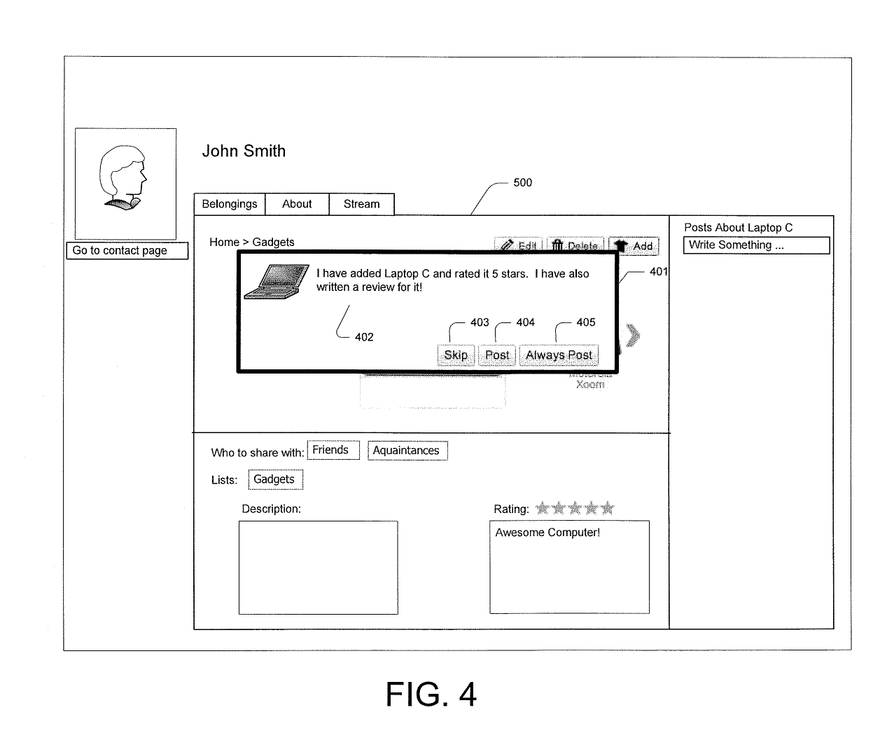

FIG. 4 illustrates a screen-shot of an example graphical user interface for viewing and sharing a post representing the belonging having been added in FIGS. 3A and 3B. The graphical user interface of FIG. 4 illustrates a prompt window 401, displaying a generated post 402 to user 130. The generated post may include a text portion and an image of the belonging. In one embodiment, the post is automatically generated by the system. The text of the post may include pre-stored text associated with adding a belonging. In one embodiment, the system may customize the post to the specific belonging added. For example, the name of the belonging (e.g., the item name entered within the item entry section of the graphical user interface of FIGS. 3A and 3B), and/or an image of the belonging (e.g., the image selected within the image selection 306 of the graphical user interface of FIG. 3B), may be added to pre-stored text retrieved by the system.

The graphical user interface of FIG. 4 further illustrates a set of buttons, including the “skip” button 403, the “post” button 404 and the “always post” button 405, being displayed within prompt window 401. User 130, after viewing the post 402, may select to not share the post with contacts by selecting the skip button 403. Alternatively, user 130 may choose to share the post 402 with selected contacts (e.g., contacts selected within the content selection section 302 of the graphical user interface of FIGS. 3A and 3B), by selecting the post button 404. The user may also decide that all posts related to the specific belonging should be shared with selected contacts without first prompting the user, by selecting the always post button 405. The selection of the always post button 405 may change the sharing preferences associated with the belonging and may be stored within the belonging profile of the belonging.

In some embodiment, the graphical user interface of FIG. 4 may allow the user to edit post 402 before sharing the post with selected contacts. For example, user 130 may be able to click the text of post 402 and edit the text. In another exemplary instance, the user may be able to change the picture associated with the post 402.

The graphical user interface of FIG. 4 illustrates the prompt window 401 as being displayed over the belonging profile 500 associated with the belonging added in FIGS. 3A and 3B. In one embodiment, the belonging profile 500 may be grayed out while prompt window 401 is being displayed. In another embodiment, prompt window 401 may be displayed simultaneously with the belonging profile 500, without being grayed out.

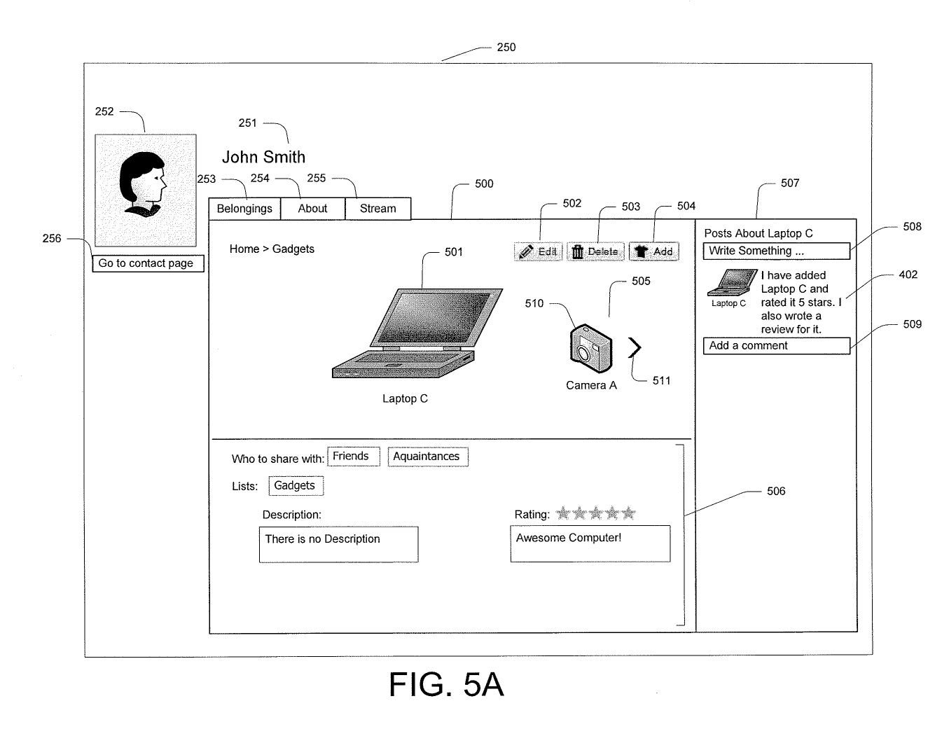

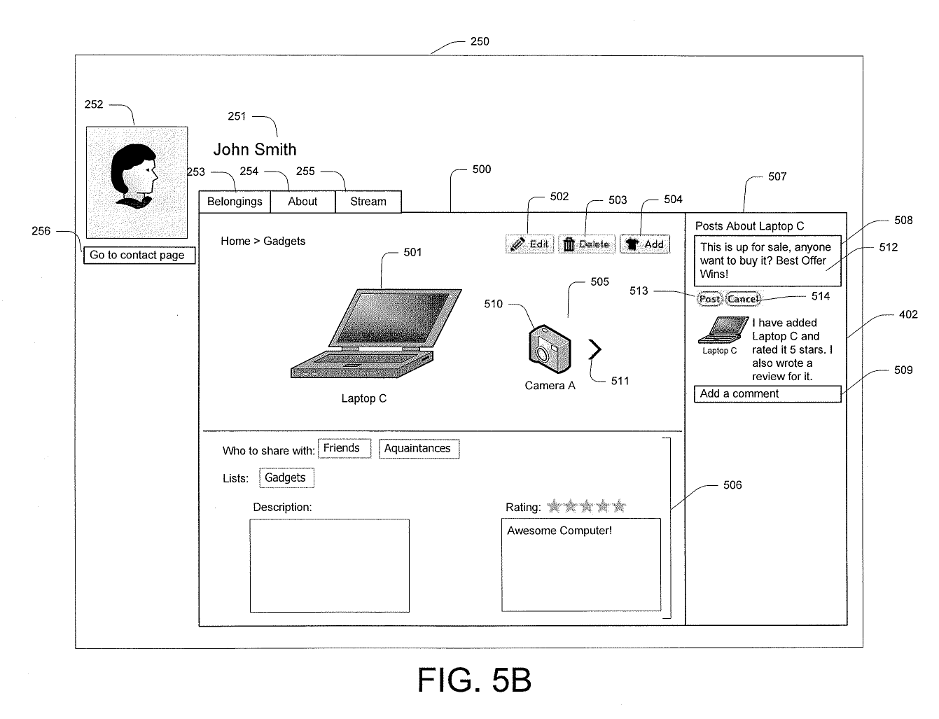

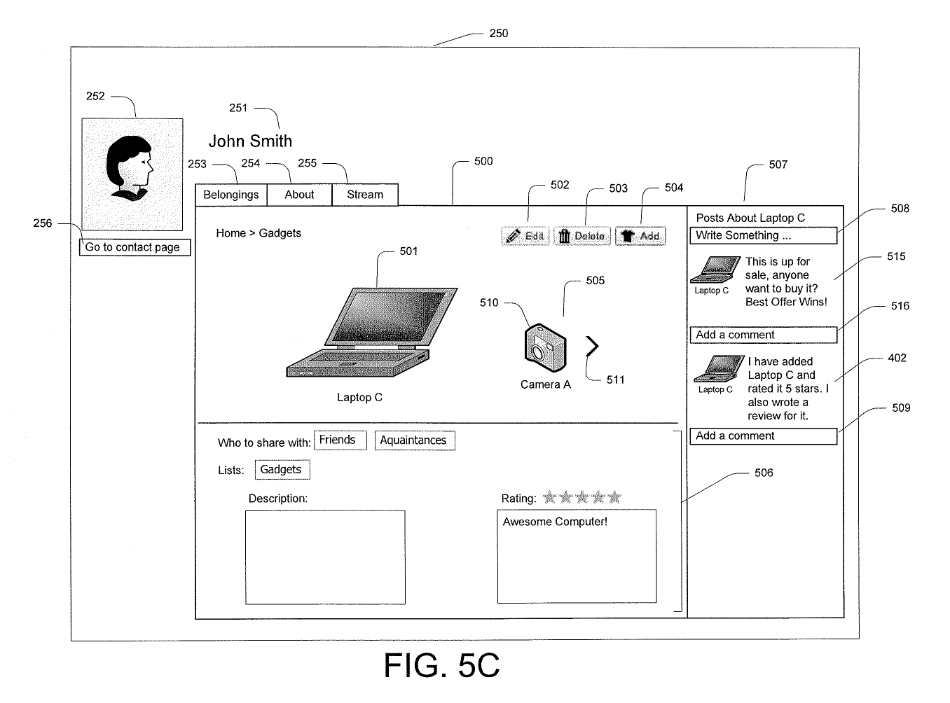

FIGS. 5A, 5B and 5C illustrate screen-shots of an example graphical user interface for viewing and managing a belonging profile of the belonging added in FIGS. 3A and 3B. In some aspects, the graphical user interface of FIGS. 5A, 5B and 5C illustrate the belonging profile 500 of the belonging added in FIGS. 3A and 3B. The belonging profile 500 includes an image 501. The image 501 may include the image selected by user 130 within the image selection section 306 of FIG. 3B (e.g., image 309). The graphical user interface of FIGS. 5A, 5B and 5C illustrate a set of buttons that may be displayed to user 130 for modifying the belonging profile including the “edit” button 502 and “delete” button 503. Furthermore, an “add” button 504 may be provided, as illustrated in the graphical user interface of FIGS. 5A, 5B and 5C. The add button 504 may be selectable by user 130 to add a new belonging. In one embodiment, upon selecting the add button 504, user 130 is provided with a graphical user interface similar to that of FIGS. 3A and 3B and may add a new belonging.

User 130 may select the edit button 502 to modify any of the information pertaining to the belonging, including the information included with the belonging attributes section 506 of the graphical user interface of FIGS. 5A, 5B and 5C. The belonging attributes section 506 includes belonging information such as the contacts that the belonging and posts related to the belonging are shared with, the categories the belonging is organized under, a description of the belonging and a rating of the belonging that may include both a rating indication as well as a review. In one embodiment, the information displayed in the belonging attributes section 506 includes information entered by user 130 through the graphical user interface of FIGS. 3A and 3B. Additionally, user 130 may select the edit button 502 to change the image 501. In one embodiment, upon selecting the edit button, user 130 may be presented with a graphical user interface similar to those shown in FIGS. 3A and 3B.

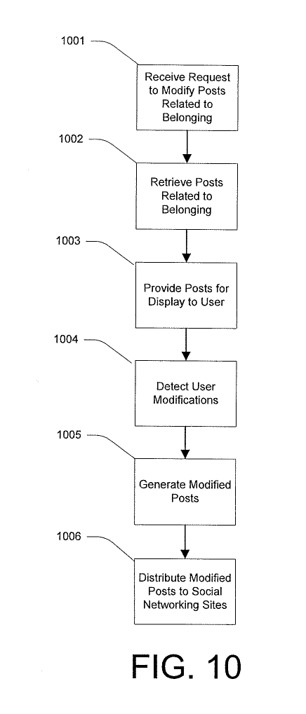

User 130 may further select to delete the entire belonging. This may be the case in various situations including, for example, when user 130 no longer owns the belonging, no longer wishes to borrow the belonging or is no longer interested in the belonging. Upon deleting the belonging, the system may retrieve all distributed and shared posts related to the belonging and may remove and or modify the posts. A similar option may be provided when the user modifies information regarding the post. The tracking and modification of posts may be performed upon a user request. For example, the system may prompt the user and provide user 130 with an option to retrieve and modify posts, or user 130 may request for the system to perform the tracking and modification without first being prompted. The process of tracking and modifying belonging-related posts is described in detail with respect to FIG. 10.

The system may detect the modification and/or deletion of the post, and may generate a post regarding the modification depending upon the sharing preferences of user 130 with regard to the belonging, as indicated by the sharing preferences selection menu 303. In one instance, depending upon the sharing preferences of user 130, the system may further display the post to the user before the post is distributed and shared with contacts of user. As indicated above, the process of generating and sharing posts is described in detail below with respect to FIG. 9.

The graphical user interface of FIGS. 5A, 5B and 5C further illustrates a belongings browse section 505 including a belonging icon 510 and a browse arrow 511. In one instance, the belonging icon 510 corresponds to an image of the next belonging within the list of belongings of user 130. In one embodiment, the browse arrow 511 allows the user to advance to the belonging profile for the next belonging. In another embodiment, the browse arrow 511 may cause the belonging icon 510 to display the next belonging within the list of belongings of the user. According to several aspects, an additional belonging browse section may further be displayed on the left side of the image 501. The additional belonging browse section may display a belonging icon of the previous belonging within the belonging list of user 130 and may further include a browse arrow for allowing user 130 to move backwards within the list of belongings of user 130.

Further illustrated in the graphical user interface of FIGS. 5A, 5B and 5C is a stream section 507. The stream section 507 may display posts associated with the belonging. As illustrated in the graphical user interface of FIGS. 5A, 5B and 5C, post 402, generated in response to adding the belonging in FIGS. 3A and 3B, is displayed within the stream section 507. A comment entry box 509 is further illustrated within the graphical user interface of FIGS. 5A, 5B and 5C. In one aspect, the comment entry box 509 allows user 130 to add a comment regarding the post 402. According to some aspects, a post entry box 508 is further illustrated within the stream section 507 of the graphical user interface of FIGS. 5A, 5B and 5C. The post entry box 508, in one embodiment, allows the user to enter a new post regarding the belonging.

The graphical user interface of FIG. 5B illustrates text 512 entered within the post entry box 508. The text 512 may be entered by user 130 and corresponds to a post relating to the belonging added in FIGS. 3A and 3B. In one aspect, once user 130 begins entering text within the post entry box 508, a “post” button 513 and “cancel” button 514 are displayed to user 130. At any time during entering text 512, user 130 may select the cancel button 514 to cancel the post. If user 130 does so, the belonging profile may revert to its original state, for example as illustrated in the graphical user interface of FIG. 5A.

Otherwise, user 130 may enter text 512 corresponding to a post and upon completion may select the post button 513 to share the post with selected contacts. In some embodiments, once user 130 selects the post button 513, the system may detect that a new post regarding the belonging has been added. The system may then generate a post 515 and may display the post within the stream section 507, as illustrated in the graphical user interface of FIGS. 5A, 5B and 5C. In one aspect, the post 515 includes the text 512 and may further include an image of the belonging (e.g., image 501).

Upon receiving the post selection from user 130 and generating post 515, the system may initiate the process of distributing the post to selected contacts of the user. The contacts of the user may include those contacts specified within the contacts selection section 302 of FIGS. 3A and 3B, and displayed within the belonging attributes section 506. In one aspect, the distribution may depend upon the sharing preferences selected by user 130 regarding the belonging (e.g., through the sharing preference selection menu 303 of the graphical user interface of FIGS. 3A and 3B or through the prompt window 401 by selecting the always post button 405). The process of generating and distributing a post is described further below with respect to FIG. 9.

Once post 515 is generated and displayed, as illustrated in the graphical user interface of FIG. 5C, comment entry box 516 for receiving comments regarding post 515 is displayed to the user. In one aspect, comment entry box 516 allows user 130 to add a comment regarding post 515.

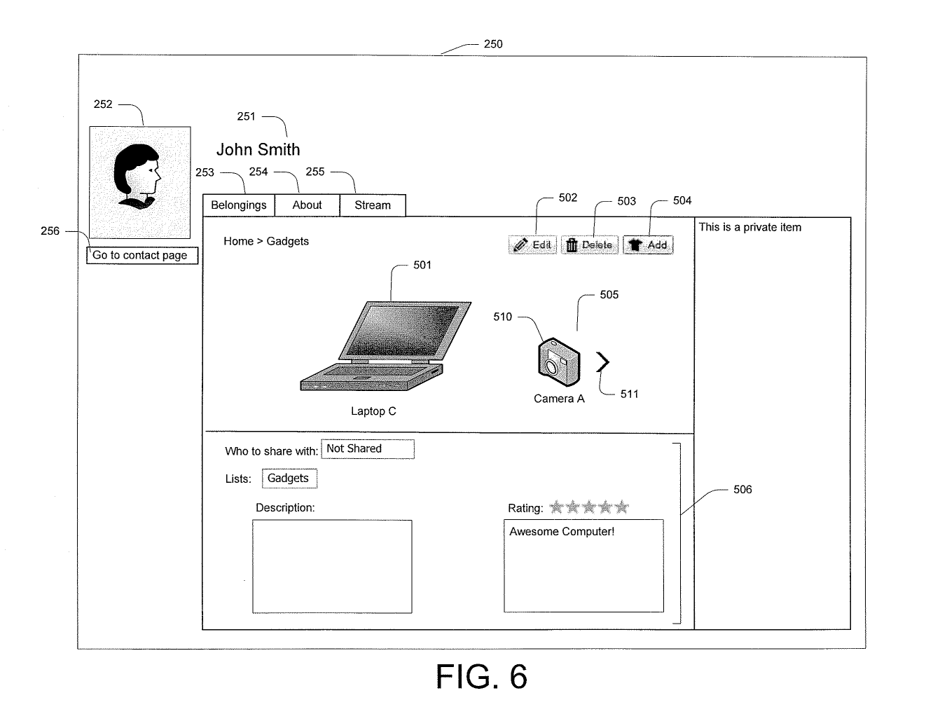

FIG. 6 illustrates a screen-shot of an example graphical user interface for viewing and managing a belonging profile of a private belonging. As described above, in some aspects, user 130 may choose to never share posts regarding the belonging added in FIGS. 3A and 3B (e.g., by choosing the never share option within the sharing preferences selection menu 303). In some aspects, if user 130 makes such selection, the belonging profile may be made private as illustrated in the graphical user interface of FIG. 6. The graphical user interface of FIG. 6, according to one or more aspects, is similar to that of FIGS. 5A, 5B and 5C, illustrating an image 501 of the belonging, the “edit” button 502, the “delete” button 503, the “add” button 504, a belonging browse section 505 and a belonging attributes section 506.

However, unlike the graphical user interface of FIGS. 5A, 5B and 5C, the private belonging profile illustrated in the graphical user interface of FIG. 6 may not include a stream section. Posts regarding a private belonging may not be shared with other users, and further may not be displayed within the belonging profile. In some aspects, when a belonging profile is made private, the system may not generate posts regarding the belonging regardless of whether actions are taken with regard to the belonging. This may persist, in several aspects, unless user 130 changes the sharing preferences, for example by selecting the edit button 502 and changing the sharing preferences (e.g., using a sharing preferences selection menu similar to the sharing preferences selection menu 303 of the graphical user interface of FIGS. 3A and 3B).

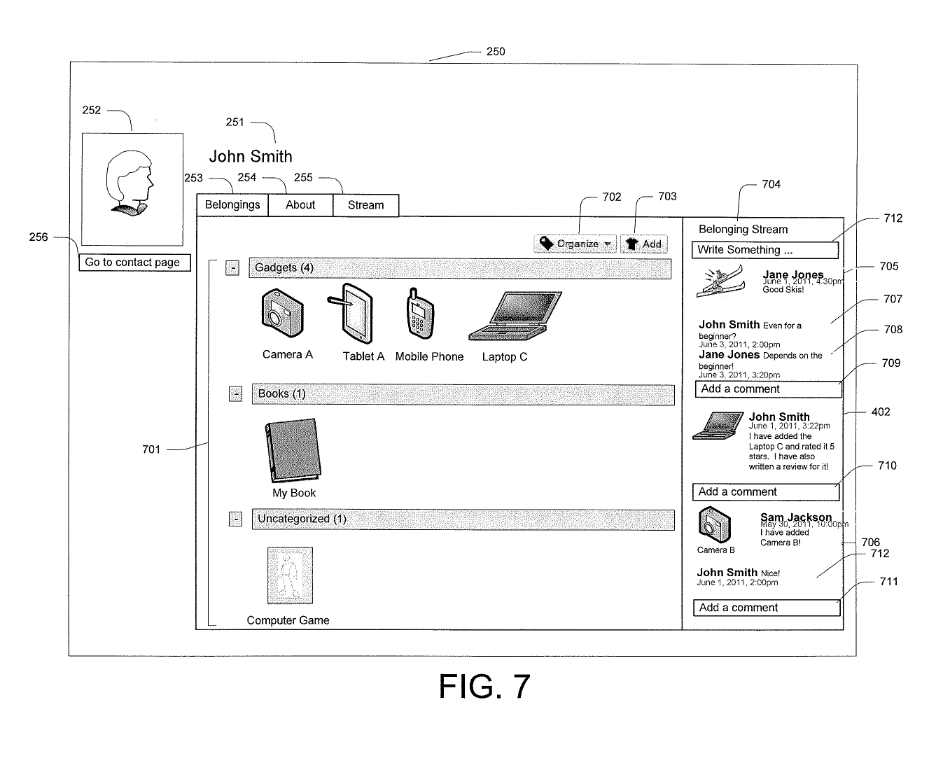

FIG. 7 illustrates a screen-shot of an example graphical user interface for viewing and managing a belonging profile of a user. The graphical user interface of FIG. 7 illustrates a belonging section 701 displaying the belongings of user 130 including the belonging added in FIGS. 3A and 3B. As illustrated, according to some aspects, the belongings are organized into belonging categories. In this exemplary user profile, the belonging categories include gadgets, books and an uncategorized belonging category for uncategorized belongings added by user 130. As described above, in one aspect, a belonging may be assigned to one or more belonging categories when it is being added (e.g., within the belonging categorization section 304 of the graphical user interface of FIGS. 3A and 3B). In one embodiment, if user 130 does not assign the belonging to any belonging category, then the belonging may be automatically organized under the uncategorized belonging category. In another embodiment, user 130 may place belongings within the uncategorized belonging category, for example, when user 130 is not sure what category to assign to the belonging.

The graphical user interface of FIG. 7 further illustrates an “organize” button 702 and an “add” button 703. In one embodiment, by selecting the organize button 702, user 130 may reorganize the belongings, such that different belongings may be organized under different belonging categories. In some aspects, user 130 may additionally be able to create new belonging categories. The add button 703 may be selected by user 130 to add a new belonging. In one embodiment, upon selecting the add button 703, user 130 may be provided with a graphical user interface similar to the graphical user interface illustrated in FIGS. 3A and 3B and may create a new belonging. In some aspects, all belongings displayed within the belonging section 701 are associated with user 130 within the social graph of belongings maintained by the system. The process of generating and maintaining the social graph of belongings is described in detail below with respect to FIG. 8.

The graphical user interface of FIG. 7 illustrates a stream section 704. In some aspects, stream section 704 displays one or more posts related to belongings. In one embodiment, the one or more posts include posts shared with user 130 by other users of the system (e.g., users 132 and 134), or posts of user 130 (e.g., posts generated in response to adding a belonging or performing some other activity with relation to a belonging). For example, the graphical user interface of FIG. 7 illustrates posts 705 and 706 added by other users of the system and shared with user 130, as well as post 402 generated in response to user 130 adding the belonging in FIGS. 3A and 3B.

In one aspect, the stream section 704 further includes comments 707 and 708, associated with post 705. Further illustrated within the graphical user interface of FIG. 7, each post includes a comment entry box, 709-711. In one aspect, each comment entry box 709-711 allows user 130 to add a comment regarding the respective post 705, 402 and 706. According to some aspects, a post entry box 712 is further illustrated within the stream section 704 of the graphical user interface of FIG. 7. The post entry box 714, in one embodiment, allows the user to enter a new post. The post entry box 714 of the graphical user interface of FIG. 7 may function similarly to the post entry box 508 illustrates in the graphical user interface of FIGS. 5A, 5B and 5C.

FIG. 8 illustrates a flow chart illustrating a process 800 for generating and maintaining a social graph of belongings. The process 800 begins in step 801 when the system detects a user request to add a new belonging, for example from user 130. In some aspects, the request may be detected when user 130 selects to add a belonging, for example by selecting the add button when viewing a graphical user interface of a belonging profile (e.g., add button 504 of the graphical user interface of FIGS. 5A, 5B, 5C and 6) or when viewing a graphical user interface of a user profile (e.g., add button 703 of the graphical user interface of FIG. 7). Alternatively, the system may detect the user request to add a new belonging when user 130 selects a suggested belonging within the graphical user interface provided to the user first logs into the system (e.g., the graphical user interface of FIG. 2).

Next, in step 802 the system displays a graphical user interface to user 130 for adding a new belonging. The graphical user interface may be similar to that displayed in FIGS. 3A and 3B. As described above, user 130 may then enter attributes regarding the belonging, such as a name of the belonging, an image of the belonging, contacts to share activities related to belongings with, belonging categories associated with the belonging, a belonging sharing preference, belonging description, belonging review and ranking, belonging state and belonging purchase information. In some embodiments, the attributes may be similar to those illustrated in the graphical user interface of FIGS. 3A and 3B.

In step 803, the system receives a belonging input from the user. For example, the user may select the save item button 308 of the graphical user interface of FIGS. 3A and 3B, and the information regarding the belonging may then be received by the system. Alternatively, user 130 may select the save item button 208 of the graphical user interface of FIG. 2 when selecting a suggested belonging. In one instance, where the user is selecting a suggested belonging, step 802 may be skipped and the user may simply select one of the suggested belongings and select to save the item as a belonging, and the system may receive the belonging in step 803. In another embodiment, upon selecting a suggested belonging, a graphical user interface similar to that of FIGS. 3A and 3B may be presented to the user and user 130 may enter information regarding the suggested belonging before requesting that the belonging be added.

Next, the process continues to step 804 in which the system generates a belonging profile based upon the information entered by user 130 and received in step 803. Next, in step 805, the system associates the belonging and/or the belonging profile with user 130. As described above, a social graph of belongings may be generated and maintained by the system. The social graph of the belongings, according to some aspects, includes associations between a user and belongings of that user for all users of the system. In step 805, the system may add the new belonging entry into the social graph of belongings as a belonging of the user 130, thus expanding the social graph of belongings through the new user-belonging association.

In some aspects, once user 130 and the belonging inputted in step 803 have been associated, the system may then generate and distribute posts related to the belonging with one or more contacts of user 130. In one embodiment, user 130 selects one or more contacts and/or groups of contacts, which the user wishes to share the user's belonging activities with. In some embodiments, adding the belonging is detected as a belonging-related activity and thus the system may initiate the process for generating and sharing a post related to the belonging with the contacts selected by the user.

FIG. 9 illustrates a flow chart illustrating a process 900 for generating a belonging-related post and sharing the post with contacts of a user. In step 901, the process 900 begins when the system detects a belonging-related activity by a user, for example user 130. As described above, the belonging-related activity may include a new belonging being added. Other examples of belonging-related activity may include a user modifying a belonging, deleting a belonging, adding a new post regarding a belonging and adding a new comment regarding the belonging. The belonging-related activities listed herein may be performed through the one or more graphical user interfaces described above in FIGS. 2-7.

Upon detecting the belonging-related activity, in step 902 the system retrieves sharing preferences with respect to the belonging. The sharing preference of a belonging may be stored within the belonging profile of the belonging generated in step 804 of process 800. As described above, a user (e.g., user 130), may set the sharing preferences by selecting a sharing preference from the sharing preferences menu 303 of FIGS. 3A and 3B. Accordingly, user 130 may also modify the sharing preferences for a belonging already added and stored within the social graph of belongings, for example by selecting to modify the belonging, or by setting the sharing preference upon receiving a prompt, for example similar to the prompt window 401 of the graphical user interface of FIG. 4.

In step 903, based on the retrieved sharing preferences, the system may determine whether the activity detected in step 901 is associated with a private belonging. As described above, when a user selects to not share any posts regarding a belonging with contacts, the belonging may be stored as a private belonging. Similarly, the post may also be private if no contacts are selected.

If in step 903, the system determines that the belonging is a private belonging, then the process ends in step 904. Otherwise, in step 905, the system generates a post regarding the belonging-related activity detected in step 901. Generating a post may comprise generating text regarding the activity and appending an image of the belonging to the text to generate a post. The text may be system generated and pre-stored text. For example, the system may store pre-generated text associated with each specific action, and upon detecting the action, may retrieve the pre-stored and pre-generated text associated with the specific action detected in step 901. In another embodiment, the text may include user-generated text, for example, text entered within a post entry box (e.g., post entry box 508 of the graphical user interface of FIGS. 5A-5C, or post entry box 712 of the graphical user interface of FIG. 7). The image may, in some examples, correspond to the main image selected by user 130 and stored within the belonging profile of the belonging associated with the detected belonging-related activity.

Next, in step 906, the system associates the post with the belonging associated with the belonging-related activity detected in step 901, and further with user 130 associated with the belonging. In one instance, each post may be assigned a unique identifier. The unique identifier may be associated with a belonging the post is related to and/or a user associated with the belonging. In one exemplary instance, the system may track the post through the unique identifier. For example, the post may be linked with the unique identifier such that after distribution the post may be retrieved and modified using the link, even after the post has be distributed and displayed to contacts.

In step 906, a link associated with user 130 and a link associated with the belonging may further be included within the post generated in step 905. In one instance, for example, the generated post may include the name of user 130 and the name of user 130 may include a link to user 130. In one embodiment, the link to user 130 may be selectable and upon selection may access and display the belonging profile of user 130 (e.g., the user belonging profile illustrated in the graphical user interface of FIG. 7). In another instance, a link to the belonging may be included within the post. For example, in one instance the link may be inserted within the text or image of the post. The link to the post may be selectable and upon selection may access and display the belonging profile of the belonging.

In step 907, the system may determine whether user 130 should be prompted before the post is shared. For example, the system may look at the sharing preference retrieved in step 902 to determine whether user 130 has selected the prompt to post option. If it is determined that user 130 should be prompted, the process 900 continues to step 908 and prompts user 130, for example by displaying a prompt window (e.g., prompt window 401 of the graphical user interface of FIG. 4). The user may in some instances view and modify the post, before authorizing that the post be shared with contacts. Next, in step 909, the system determines whether user 130 has authorized sharing the post with contacts selected by user 130. If it is determined that user 130 has not authorized the post, then the system continues to step 904 and ends the process.

Otherwise, in step 910 the system determines contacts to share the post with. The contacts may be stored within the belonging profile. In one embodiment, the determined contacts may be associated with one or more remote social networking sites. In step 911, the system distributes the post to the one or more remote social networking sites, and requests that the post be displayed to the selected users identified in step 910. Similarly, if in step 907 it is determined that that user 130 should not be prompted, the process 900 continues to step 910 and then to step 911 where the post is distributed to the one or more remote social networking sites, requesting that the post be displayed to the determined contacts at the one or more remote social networking sites.

The one or more remote social networking sites may provide API functionality for receiving and posting posts. In such embodiments, the system generates an API call to each of the one or more remote social networking sites to display the post. In one instance, the post may be displayed along with other posts by user 130 within the one or more remote social networking sites and shared with the one or more determined contacts. The post may further be stored within a database maintained by the system. A date and time associated with the posts (e.g., the time the post was created, generated or stored) may be stored with the post for later retrieval and display within a belonging specific stream.

Upon being displayed at the remote social networking site, the selected contacts may then enter feedback or reviews regarding the post at the social networking site. The comments and feedbacks are associated with the post and may be retrieved and stored in the database of posts and comments along with the post. For example, each post may include a unique identifier, and posts and comments created by contacts in connection with the post may be associated with the unique identifier such that the comments and posts associated with the post may be retrieved from the remote social networking site and displayed to the user locally when interacting with the graphical user interface of the system.

After distribution, the post may be retrieved and modified using the unique identifier, the link to the user and/or the link to the belonging. For example, a user may modify information regarding the belonging, may delete the belonging or may perform other activity with respect to the belonging. In such instances, it may be beneficial to update the posts related to the belonging in view of the action performed by the user.

FIG. 10 illustrates a flow chart of a process 1000 for tracking and modifying belonging-related posts. The posts may be already distributed and displayed to contacts locally and/or at one or more remote social networking sites. The process 1000 begins in step 1001 where the system detects a request to modify posts. In one embodiment, the request may be for retrieving all posts related to a user, while in other embodiments, the request may be for retrieving posts related to a belonging of the user. Such a request may be detected for example when the user requests to retrieve and modify all posts, posts related to a belonging, or may be automatically detected when a modification is made with respect to a belonging, such as when the belonging is deleted, given away or sold, or when the user is no longer associated with the system (e.g., when the user deactivates his/her account).

In step 1002, the system retrieves posts related to the belonging. In one instance, all posts related to the belonging may be retrieved, while in other instances, only specific posts may be retrieved. In step 1002, the system may detect posts associated with the request and retrieve those posts. As described above, each post may be assigned a unique identifier and may further include a link to the user and the belonging. The system may use the unique identifier and/or the links embedded within the post to retrieve the post.

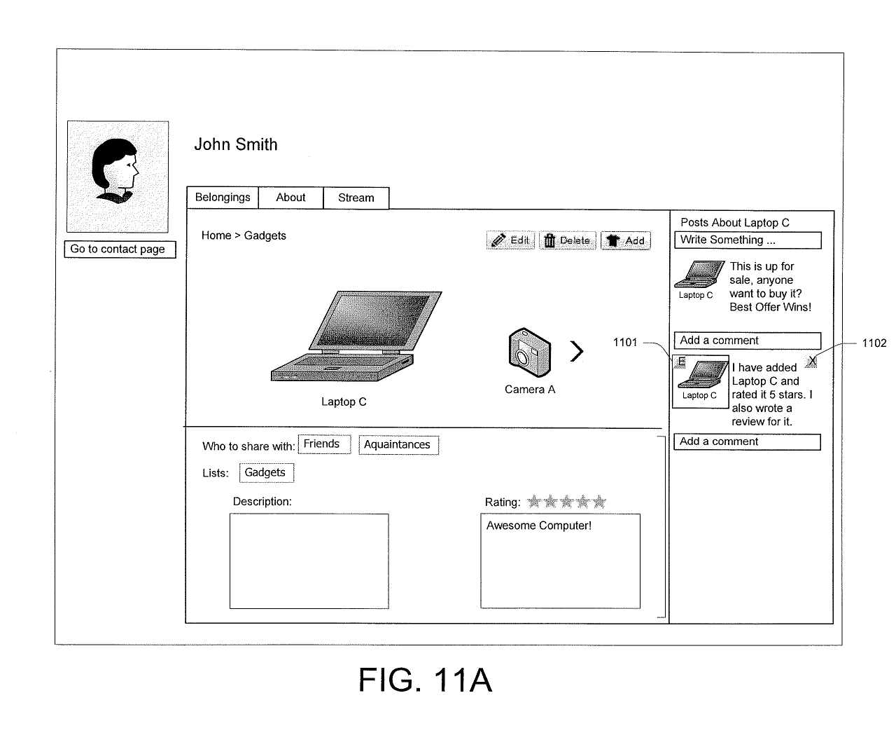

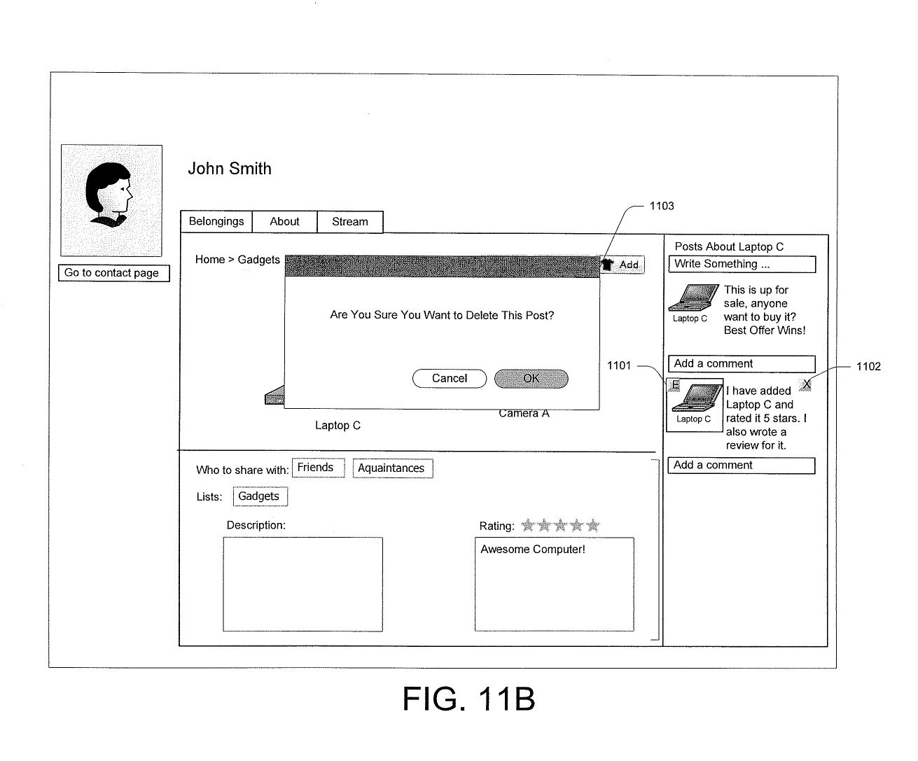

In step 1003, all retrieved posts may be displayed to the user. The user may then view the posts and modify one or more posts, including modifying the text of the post and/or the image included within the post. Alternatively, in step 1003, the system may automatically modify one or more of the retrieved posts. In one exemplary instance, step 1003 may not be performed where the posts are modified in response to a system detection and seamlessly without notification to the user. An exemplary graphical user interface displayed to the user for modifying a belonging related post is illustrated below with respect to FIGS. 11A and 11B.

The modifications to the posts are detected in step 1004. The modifications may be user generated, system generated or may be a combination thereof. In step 1005, the system generates modified posts according to the detected modifications. In one embodiment, the modified posts are generated in a similar manner as describe above with respect to generating an original post associated with a belonging-related activity (e.g., process steps 905 and 906 of FIG. 9). In some instances, the modified posts each comprise a link to the user and a link to the belonging associated with the modified posts. The modified posts may each be associated with their respective unique identifier, or may alternatively be associated with a new unique identifier.

Next, in step 1006 of process 1000 the system distributes the modified posts to the one or more remote social networking sites to be displayed to selected contacts. In one embodiment, step 1006 is performed in a similar manner as steps 908 and 909 of FIG. 9 described above. Additionally, in some instances, steps similar to steps 903, 907 and 909 of FIG. 9 may further be performed with respect to the modified posts generated during the process 1000.

FIG. 11A illustrates a screen shot of an exemplary graphical user interface for modifying a belonging-related post. In the exemplary graphical user interface of FIG. 11A the user may modify the post from a belonging-related stream displaying one or more posts related to a specific belonging. The user may select an icon next to each post (e.g., icon 1101) for editing the post. Upon selecting the icon, the post may be presented to the user in editable form and the user may edit the post. Similarly, a second icon (e.g., icon 1102) may be provided to the user for deleting the post. In one example, a single icon may be provided in lieu of icons 1101 and 1102. Upon the user pressing the icon, the user may be presented with a drop down menu and may select to edit or delete the post using the drop down menu. Upon selecting the icon and performing an edit or deletion, the user may be presented with a confirmation message for confirming the edit or deletion of the post. FIG. 11B illustrates a screen shot of an exemplary graphical user interface providing a confirmation message 1103 to the user. Upon receiving confirmation from the user, the system detects the modification to the post.

FIG. 12 illustrates an exemplary social graph of belongings. As illustrated, the social graph of belongings includes one or more users. Each of the one or more users is associated with one or more belongings. Furthermore, as illustrated, the social graph of belongings may further define associations between the user and other users within the social graph of belonging (i.e., his/her contacts). The exemplary social graph of belongings includes associations among users 1-5 and further defines associations between each of the users 1-5 and one or more belongings.

More specifically, user 1 is associated with user 2, user 4 and user 5. Furthermore, User 1 is associated with belongings including “Camera A”, “Tablet A”, “Mobile Phone” and “Laptop C”. User 2 is illustrated as being associated with user 1, user 3 and user 5, and with belongings including “SKIS” and “MOBILE A”. User 3 is illustrated as being associated with user 2 and user 4, and further with belongings including “CAR B”, “BOOK C” and “JACKET S”. User 4 is illustrated as associate with user 1 and user 3 and belongings including “TV A” and “My Kix”. Finally, User 5 is illustrated as being associated with user 1 and user 2 and with belongings including “TABLET A” and “SUNGLASSES A”.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

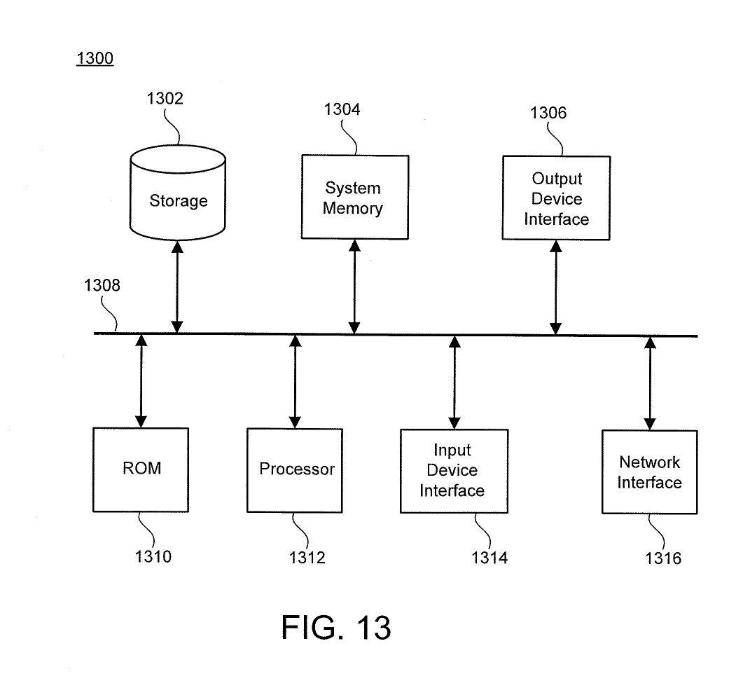

FIG. 13 conceptually illustrates an electronic system with which some implementations of the subject technology are implemented. Electronic system 1300 can be a computer, phone, PDA, or any other sort of electronic device. Such an electronic system includes various types of computer readable media and interfaces for various other types of computer readable media. Electronic system 1300 includes a bus 1308, processing unit(s) 1312, a system memory 1304, a read-only memory (ROM) 1310, a permanent storage device 1302, an input device interface 1314, an output device interface 1306, and a network interface 1316.

Bus 1308 collectively represents all system, peripheral, and chipset buses that communicatively connect the numerous internal devices of electronic system 1300. For instance, bus 1308 communicatively connects processing unit(s) 1312 with ROM 1310, system memory 1304, and permanent storage device 1302.

From these various memory units, processing unit(s) 1312 retrieves instructions to execute and data to process in order to execute the processes of the subject disclosure. The processing unit(s) can be a single processor or a multi-core processor in different implementations.

ROM 1310 stores static data and instructions that are needed by processing unit(s) 1312 and other modules of the electronic system. Permanent storage device 1302, on the other hand, is a read-and-write memory device. This device is a non-volatile memory unit that stores instructions and data even when electronic system 1300 is off. Some implementations of the subject disclosure use a mass-storage device (such as a magnetic or optical disk and its corresponding disk drive) as permanent storage device 1302.

Other implementations use a removable storage device (such as a floppy disk, flash drive, and its corresponding disk drive) as permanent storage device 1302. Like permanent storage device 1302, system memory 1304 is a read-and-write memory device. However, unlike storage device 1302, system memory 1304 is a volatile read-and-write memory, such a random access memory. System memory 1304 stores some of the instructions and data that the processor needs at runtime. In some implementations, the processes of the subject disclosure are stored in system memory 1304, permanent storage device 1302, and/or ROM 1310. For example, the various memory units include instructions for processing multimedia items in accordance with some implementations. From these various memory units, processing unit(s) 1312 retrieves instructions to execute and data to process in order to execute the processes of some implementations.

Bus 1308 also connects to input and output device interfaces 1314 and 1306. Input device interface 1314 enables the user to communicate information and select commands to the electronic system. Input devices used with input device interface 1314 include, for example, alphanumeric keyboards and pointing devices (also called “cursor control devices”). Output device interfaces 1306 enables, for example, the display of images generated by the electronic system 1300. Output devices used with output device interface 1306 include, for example, printers and display devices, such as cathode ray tubes (CRT) or liquid crystal displays (LCD). Some implementations include devices such as a touchscreen that functions as both input and output devices.

Finally, as shown in FIG. 13, bus 1308 also couples electronic system 1300 to a network (not shown) through a network interface 1316. In this manner, the computer can be a part of a network of computers (such as a local area network (“LAN”), a wide area network (“WAN”), or an Intranet, or a network of networks, such as the Internet. Any or all components of electronic system 1300 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system may be interconnected by any form or medium of digital data communication, e.g., a communication network. While several components or steps are described as being performed by the system, it should be understood that various components and steps may be performed by different systems in communication with one another, e.g., through a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for creating a new association of a belonging with a user within a social graph of belongings, the method comprising:
receiving an input of a belonging from a first user of one or more users;
generating a belonging profile associated with the belonging;
associating the belonging profile with the first user within a social graph of belongings;
generating a post, wherein the post comprises a link to the belonging profile and a link to the first user; and
transmitting the post to be displayed to one or more contacts of the first user on a remote social networking site.

2. The method of claim 1, wherein the social graph of belongings defines an association between each of the one or more users and one or more belongings.

3. The method of claim 1, further comprising:
receiving a user request to add the belonging; and
displaying a graphical user interface to the first user for user entry of information regarding the belonging in response to the request.

4. The method of claim 3, wherein the information includes one or more of a belonging name, a belonging image, a belonging sharing preference, a belonging review, a belonging rating, a belonging description, the one or more contacts and a belonging category.

5. The method of claim 3, further comprising:
receiving entry of the information regarding the belonging entered within the graphical user interface by the first user,
wherein the generating step comprises generating the belonging profile to include the entered information.

6. The method of claim 1, further comprising:
detecting a sharing preference associated with the belonging; and
determining whether the first user wishes to share activities regarding the belonging with the one or more contacts, based on the sharing preference;
wherein the steps of generating the post and transmitting the post to be displayed to the one or more contacts at the remote social networking site are performed when it is determined that the first user wishes to share activities regarding the belonging with the one or more contacts.

7. The method of claim 1, further comprising:
detecting a sharing preference associated with the belonging; and
determining whether the first user wishes to be prompted before the post is displayed to the one or more contacts, based on the sharing preference; and
prompting the first user for authorization when it is determined that the first user wishes to be prompted; and
determining whether the first user has authorized the post;
wherein the step of transmitting the post to be displayed to the one or more contacts of the first user on the remote social networking site is performed when it is determined that the first user has authorized the post.

8. The method of claim 1, wherein the one or more contacts comprise contacts of the first user at the remote social networking site.

9. The method of claim 1, wherein the link to the belonging profile is selectable and configured to access and display the belonging profile upon selection.

10. The method of claim 1, wherein the link to the first user is selectable and configured to access and display a user belonging profile associated with the first user upon selection, the user belonging profile comprising a listing of one or more belongings associated with the first user including the belonging, the one or more belongings being organized into one or more belonging categories.

11. The method of claim 1, wherein the post is associated with a unique identifier.

12. A system for creating a new association of a belonging with a user within a social graph of belongings, the system comprising:
one or more processors; and
a machine-readable medium comprising instructions stored therein, which when executed by the processors, cause the processors to perform operations comprising:
receiving an input of a belonging from a first user of one or more users, wherein the input comprises information regarding the belonging;
generating a belonging profile associated with the belonging, the belonging profile comprising the information; and
associating the belonging profile with the first user within a social graph of belongings, wherein the social graph of belongings defines an association between each of the one or more users and one or more belongings.

13. A machine-readable medium comprising instructions stored therein, which when executed by a machine, cause the machine to perform operations comprising:
receiving an input of a belonging from a first user of one or more users;
generating a belonging profile associated with the belonging;
associating the belonging profile with the first user within a social graph of belongings;
generating a post, wherein the post comprises a link to the belonging profile and a link to the first user;
retrieving a list of a plurality of contacts of the first user from a remote social networking site, the plurality of contacts comprising contacts of the first user at the remote social networking site; and
transmitting the post to be displayed to one or more of the plurality of contacts of the first user on the remote social networking site.

14. A method for retrieving and modifying belonging-related posts, the method comprising:
receiving a request to modify at least one post associated with a belonging, the post being displayed at a remote social networking site;
retrieving the at least one post from the remote social networking site, wherein retrieving the at least one post comprises retrieving a unique identifier associated with the at least one post and retrieving the at least one post using the unique identifier;
detecting one or more modifications of the at least one post;
generating a modified post; and
transmitting the modified post to be displayed to one or more contacts of the user on the remote social networking site.

15. The method of claim 14, further comprising displaying the at least one post to the user, wherein the one or more modifications of the at least one post are performed by the user.

16. The method of claim 14, wherein the step of receiving the request to modify the at least one post comprises receiving a request from a user to modify the at least one post.

17. The method of claim 14, wherein the step of receiving the request to modify the at least one post comprises detecting that the first user has modified information regarding the belonging.

18. The method of claim 14, wherein the at least one post is removed from the remote social networking site and replaced with the modified post in response to the step of transmitting the modified post to be displayed to one or more contacts of the user on the remote social networking site.

19. The method of claim 14, wherein the modified post comprises a link to the belonging the belonging and a link to a user associated with the belonging.

20. The method of claim 14, wherein the belonging is associated with a first user of one or more users within a social graph of belongings, wherein the social graph of belongings defines an association between each of the one or more users and one or more belongings.

21. The method of claim 14, further comprising associating the modified post with the unique identifier.

22. A system for retrieving and modifying belonging-related posts, the system comprising:
one or more processors; and
a machine-readable medium comprising instructions stored therein, which when executed by the processors, cause the processors to perform operations comprising:
receiving a request to modify at least one post associated with a belonging, the at least one post being displayed at a remote social networking site, wherein the belonging is associated with a first user of one or more users within a social graph of belongings, wherein the social graph of belongings defines an association between each of the one or more users and one or more belongings;
retrieving the at least one post from the remote social networking site, wherein retrieving the at least one post comprises retrieving the at least one post using a unique identifier associated with the post;
detecting one or more modifications of the at least one post;
generating a modified post; and
transmitting the modified post to be displayed to one or more contacts of the user on the remote social networking site.

23. A machine-readable medium comprising instructions stored therein, which when executed by a machine, cause the machine to perform operations comprising:
receiving a request to modify at least one post associated with a belonging, the at least one post being displayed at a remote social networking site, wherein the belonging is associated with a first user of one or more users within a social graph of belongings, wherein the social graph of belongings defines an association between each of the one or more users and one or more belongings;
retrieving the at least one post from a remote social networking site, wherein retrieving the at least one post comprises retrieving a unique identifier associated with the at least one post and retrieving the at least one post using the unique identifier;
detecting one or more modifications of the at least one post;
generating a modified post, the modified post having a link to the belonging and a link to the first user; and
associating the post with the unique identifier.
